(19) United States
(12) Patent Application Publication
(10) Pub. No.: US 2018/0265261 A1
(43) Pub. Date: Sep. 20, 2018

(54) ENCAPSULATION STRUCTURE FOR CONTAINER

(71) Applicant: TAIWAN FOREVER INDUSTRY CO., LTD., TAIPEI CITY (TW)

(72) Inventor: HSIEN-LIANG CHANG, TAIPEI CITY (TW)

(21) Appl. No.: 15/987,253

(22) Filed: May 23, 2018

Related U.S. Application Data
(63) Continuation-in-part of application No. 14/597,317, filed on Jan. 15, 2015.

(51) Int. Cl. B65D 41/04; B65D 53/04; B32B 15/08; B32B 15/20; B32B 5/18

(52) U.S. Cl. CPC B65D 41/045; B65D 53/04; B32B 15/08; B32B 2435/02; B32B 5/18; B32B 2250/04; B32B 15/20

(57) ABSTRACT

An encapsulation structure for a container comprising a sealing layer, having a plastic layer, an aluminum layer and a heat-sealing adhesive layer, wherein the plastic layer is disposed on the aluminum layer and the aluminum layer is sealed on the rim of the container by the heat-sealing adhesive layer; a strippable foamed-plastic layer engaged in the cap of the container; and a strippable adhesive layer by which the strippable foamed-plastic layer may be adhered to the plastic layer; wherein, after heating the cap, the strippable foamed-plastic layer, the strippable adhesive layer, the sealing layer and the container by electromagnetic induction, the adhesion force of the strippable adhesive layer is smaller than that of the heat-sealing adhesive layer; and, when the cap is opened, the strippable foamed-plastic layer will be detached from the sealing layer along with the cap.

### CROSS-REFERENCE TO RELATED APPLICATION

This application is a continuation-in-part patent application of U.S. application Ser. No. 14/597,317 filed on Jan. 15, 2015, the entire contents of which are hereby incorporated by reference for which priority is claimed under 35 U.S.C. § 120.

### FIELD OF THE INVENTION

The invention relates to an encapsulation structure for a container, and more particularly, to an encapsulation structure for a container that is environmentally friendly, reduces consumed materials, may be partially recyclable, and may securely seal the container.

### BACKGROUND OF THE INVENTION

Before conventional encapsulation structures for containers are heated by electromagnetic induction, a foamed-plastic layer, a paper layer, a wax layer, a plastic protective film, an aluminum layer, and a heat-sealing adhesive layer are sequentially arranged from the cap to the rim; after being heated by electromagnetic induction, the wax layer is melted and absorbed by the paper layer, and the aluminum layer is sealed on the rim by the heat-sealing adhesive layer and the foamed-plastic layer (including the paper layer) is engaged in the cap. However, since conventional encapsulation structures for containers use paper layers to absorb wax layers that are not easily decomposed, they are not environmentally friendly once being formed as a plastic pad structure including paper layers (containing wax layers); in addition, due to the usage of such wax layers in conventional encapsulation structures for containers, paper layers should be added to absorb the melted wax layers, which wastes more consumed materials. Furthermore, as conventional encapsulation structures for containers use wax layers, after the paper layer absorbed the melted wax layer, the conventional encapsulation structure for container including the paper layer may become molded while being applied for containers containing liquid content, and thus the foamed-plastic layers of conventional encapsulation structures after forming with plastic pad structure cannot be recycled. Moreover, as conventional encapsulation structures for containers use wax layers, the adhesion of such wax layers may be easily stripped off due to too high temperature during shipment or storage. In addition, since conventional encapsulation structures for containers have poor heat conduction for rims of large areas, it is difficult for the wax layer to be melted causing the wax layer will be difficult to be stripped off and the cap cannot be opened.

Therefore, an encapsulation structure for a container that is environmentally friendly, reduces consumed materials, may be partially recyclable, and may securely seal the container shall be disclosed by the present invention.

### SUMMARY OF THE INVENTION

In view of the above shortcomings of prior art, great research effort was devoted to overcome such imperfections, and an encapsulation structure for a container that achieves the purposes of being environmentally friendly, reducing consumed materials, being partially recyclable, and securely sealing the container is developed.

To achieve the above and other purposes, an encapsulation structure for a container in the present invention is provided to comprise: a sealing layer, having a plastic layer, an aluminum layer and a heat-sealing adhesive layer, wherein the plastic layer is disposed on the aluminum layer and the aluminum layer is sealed on the rim of a container by the heat-sealing adhesive layer; a strippable foamed-plastic layer engaged in the cap of the container; and a strippable adhesive layer, by which the strippable foamed-plastic layer is adhered to the plastic layer; wherein, after heating the cap, the strippable foamed-plastic layer, the strippable adhesive layer, the sealing layer and the container by electromagnetic induction, the adhesion force of the strippable adhesive layer is smaller than that of the heat-sealing adhesive layer, and when the cap is opened, the strippable foamed-plastic layer will be detached from the sealing layer along with the cap.

In the above encapsulation structure for a container, the plastic layer is provided with a plastic protective film thereon, and the strippable foamed-plastic layer is adhered to the plastic protective film by the strippable adhesive layer.

In the above encapsulation structure for a container, the plastic protective film is transparent.

In the above encapsulation structure for a container, the strippable foamed-plastic layer is provided with a pattern layer thereon that is opposite to the plastic layer.

In the above encapsulation structure for a container, the strippable foamed-plastic layer is provided with a pattern layer thereon that is opposite to the plastic protective film.

In the above encapsulation structure for a container, the strippable adhesive layer is a strippable polyurethane (PU) adhesive layer.

By the above embodiments, the encapsulation structure for a container of the present invention may be environmentally friendly, reduce consumed materials, be partially recyclable, and securely seal the container.

### BRIEF DESCRIPTION OF THE DRAWINGS

FIG. 1 is an exploded diagram of a preferred embodiment of the invention; and

FIG. 2 is a cross-section assembly diagram of a preferred embodiment of the invention.

### DETAILED DESCRIPTION OF THE PREFERRED EMBODIMENTS

The purposes, features, and effects of the invention may be more fully understood by the subsequent detailed description and embodiments with references made to the accompanying drawings.

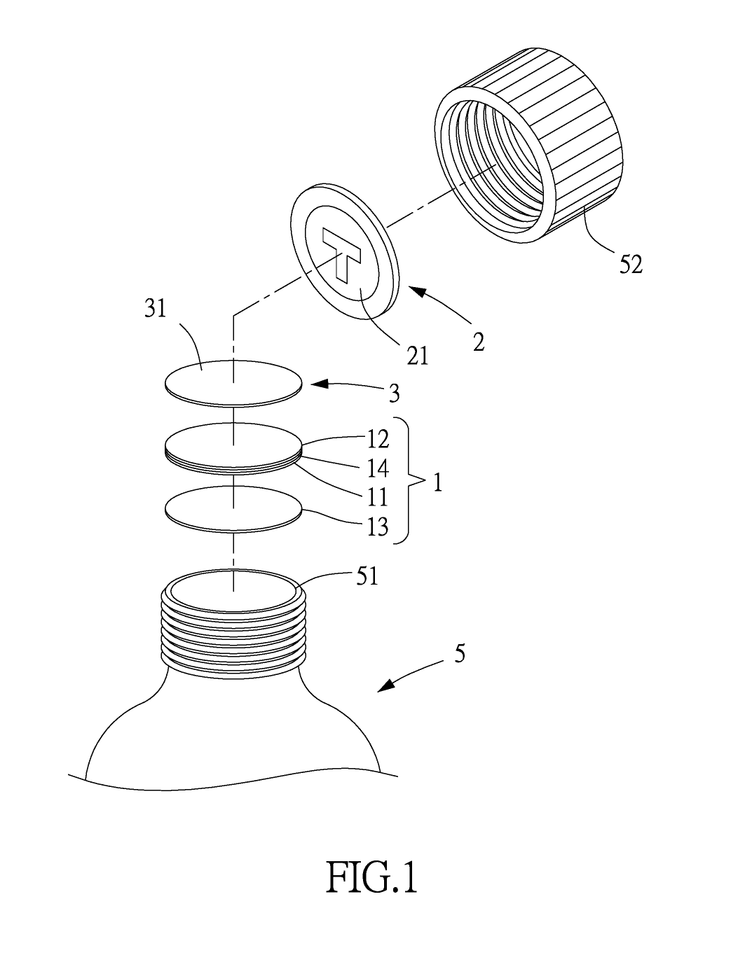

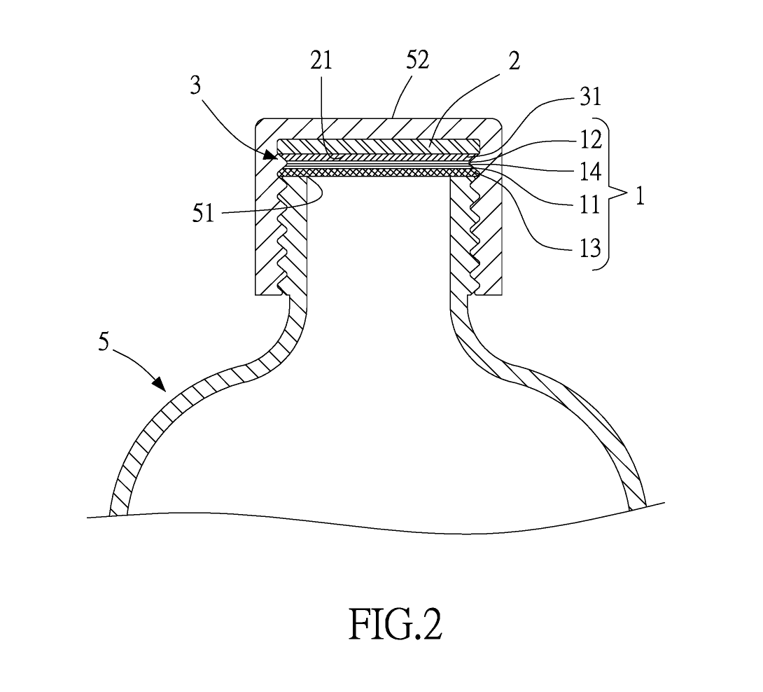

As shown in FIG. 1 and FIG. 2, the invention provides an encapsulation structure for a container comprising a sealing layer 1, a strippable foamed-plastic layer 2, and a strippable adhesive layer 3. The sealing layer 1 comprises a plastic layer 14, an aluminum layer 11 and a heat-sealing adhesive layer 13. The plastic layer 14 is adhered on the aluminum layer 11. The aluminum layer 11 is sealed on a rim 51 of the container 5 by the heat-sealing adhesive layer 13. The heat-sealing adhesive layer 13 may be located on the periphery below the aluminum layer 11 to be correspondingly adhered onto the periphery of the rim 51. The strippable foamed-plastic layer 2 is engaged in a cap 52 of the container 5. The strippable foamed-plastic layer 2 is adhered to the plastic layer 14 by the strippable adhesive layer 3. After heating the cap 52, the strippable foamed-plastic layer 2, the strippable adhesive layer 3, the sealing layer 1 and the container 5 by electromagnetic induction, the adhesion force of the strippable adhesive layer 3 is smaller than that of the heat-sealing adhesive layer 13, so when the cap 52 is opened, the strippable foamed-plastic layer 2 will be detached from the sealing layer 1 and the container 5 along with the cap 52. Before the encapsulation structure for a container of the present invention is heated by electromagnetic induction, the plastic layer 14 and the aluminum layer 11 are sealed on the rim 51 by the heat-sealing adhesive layer 13, and then the strippable foamed-plastic layer 2 is adhered to the plastic layer 14 by the strippable adhesive layer 3, and finally the cap 52 of the container 5 is covered on the strippable foamed-plastic layer 2 so that the strippable foamed-plastic layer 2 may be engaged in the cap 52 of the container 5. Subsequently, after heating the cap 52, the strippable foamed-plastic layer 2, the strippable adhesive layer 3, the sealing layer 1 and the container 5 by electromagnetic induction, the heat-sealing adhesive layer 13 may securely seal the aluminum layer 11 on the rim 51. Thus, when a user gets the container 5 and wants to remove the cap 52, since the adhesion force of the strippable adhesive layer 3 is smaller than that of the heat-sealing adhesive layer 13 due to the plastic layer 14, the strippable foamed-plastic layer 2 may be detached from the sealing layer 1 and the container 5 along with the cap 52.

As described in above, as the encapsulation structure of the present invention does not use wax, it is environmentally friendly; in addition, as the encapsulation structure of the present invention does not use wax, a paper layer is also not required to be used in the encapsulation structure of the present invention, and thus consumed materials may be reduced. Furthermore, as the encapsulation structure of the present invention does not use wax, the strippable foamed-plastic layer needs not contain paper and thus may be recycled. Moreover, as the encapsulation structure of the present invention uses the strippable adhesive layer instead of wax, the encapsulation structure of the present invention will be less affected by temperature and may have more stable adhesion force to securely seal the rim and facilitate the cap opening. Besides, the sealing layer of the encapsulation structure for container of the present invention uses the plastic layer to be adhered to the strippable foamed-plastic layer through the strippable adhesive layer, so, after heating by electromagnetic induction, the adhesion force of the strippable adhesive layer is smaller than that of the heat-sealing adhesive layer, and thus the strippable foamed-plastic layer may be easily detached from the sealing layer.

Further referring to FIG. 1 and FIG. 2, as shown, in the above encapsulation structure for container, the plastic layer 14 is provided with a plastic protective film thereon to protect the plastic layer 14, and the strippable foamed-plastic layer 2 may be adhered to the plastic protective film 12 by the strippable adhesive layer 3. Therefore, before the encapsulation structure for a container of the present invention is heated by electromagnetic induction, the plastic layer 14, the aluminum layer 11 and the plastic protective film 12 are sealed on the rim 51 by the heat-sealing adhesive layer 13, and then the strippable foamed-plastic layer 2 is adhered to the plastic protective film 12 on the plastic layer 14 by the strippable adhesive layer 3, and finally the cap 52 of the container 5 is covered on the strippable foamed-plastic layer 2 so that the strippable foamed-plastic layer 2 may be engaged in the cap 52 of the container 5. Subsequently, after heating the cap 52, the strippable foamed-plastic layer 2, the strippable adhesive layer 3, the sealing layer 1 and the container 5 by electromagnetic induction, the heat-sealing adhesive layer 13 may securely seal the plastic layer 14, the aluminum layer 11 and the plastic protective film 12 on the rim 51. Thus, when a user gets the container 5 and removes the cap 52, since the adhesion force of the strippable adhesive layer 3 is smaller than that of the heat-sealing adhesive layer 13 due to the plastic layer 14, the strippable foamed-plastic layer 2 may be detached from the sealing layer 1 along with the cap 52.

Further referring to FIG. 1 and FIG. 2, as shown, in the above encapsulation structure for a container, the plastic protective film 12 may be transparent to expose the plastic layer 14.

Further referring to FIG. 1 and FIG. 2, as shown, in the above encapsulation structure for a container, the strippable foamed-plastic layer 2 may be provided with a pattern layer 21 thereon. When there is no plastic protective film 12 on the plastic layer 14, the pattern layer 21 may be opposite to the plastic layer 14; but, when there is a plastic protective film 12 on the plastic layer 14, the pattern layer 21 may be opposited to the plastic protective film 12. The pattern layer 21 may be texts, images, or their combination. Therefore, after opening the strippable foamed-plastic layer 2, messages may be exhibited by the pattern layer 21.

Further referring to FIG. 1 and FIG. 2, as shown, in the above encapsulation structure for a container, the strippable adhesive layer 3 may be a strippable polyurethane (PU) adhesive layer 31. Therefore, the strippable PU adhesive layer 31 may adjust the adhesive strength (10 g/15 mm-200 g/15 mm) by its composition proportion; in addition, since the strippable PU adhesive layer 31 may resist the heat up to above 70° C., the strippable PU adhesive layer 31 may be prevented from damage during the electromagnetic induction heating process and may maintain the adhesive strength (10 g/15 mm-200 g/15 mm). Moreover, the strippable adhesive layer 3 may also be a strippable water-based adhesive layer. Furthermore, the adhesive strength of the heat-sealing adhesive layer 13 may become 400 g/15 mm-3500 g/15 mm after electromagnetic induction heating, so the adhesion force of the strippable adhesive layer 3 is smaller than that of the heat-sealing adhesive layer 13.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An encapsulation structure for a container, comprising:
a sealing layer, having a plastic layer, an aluminum layer and a heat-sealing adhesive layer, wherein the plastic layer is disposed on the aluminum layer and the aluminum layer is sealed on the rim of a container by the heat-sealing adhesive layer;
a strippable foamed-plastic layer, engaged in a cap of the container; and
a strippable adhesive layer, by which the strippable foamed-plastic layer is adhered to the plastic layer;
wherein, after heating the cap, the strippable foamed-plastic layer, the strippable adhesive layer, the sealing layer and the container by electromagnetic induction, the adhesion force of the strippable adhesive layer is smaller than that of the heat-sealing adhesive layer, and, when the cap is opened, the strippable foamed-plastic layer will be detached from the sealing layer along with the cap.

2. The encapsulation structure for a container as claimed in claim 1, wherein the plastic layer is provided with a plastic protective film thereon, and the strippable foamed-plastic layer is adhered to the plastic protective film by the strippable adhesive layer.

3. The encapsulation structure for a container as claimed in claim 2, wherein the plastic protective film is transparent.

4. The encapsulation structure for a container as claimed in claim 1, wherein the strippable foamed-plastic layer is provided with a pattern layer thereon that is opposite to the plastic layer.

5. The encapsulation structure for a container as claimed in claim 2, wherein the strippable foamed-plastic layer is provided with a pattern layer thereon that is opposite to the plastic protective film.

6. The encapsulation structure for a container as claimed in claim 1, wherein the strippable adhesive layer is a strippable polyurethane (PU) adhesive layer.
